(19) United States
(12) Patent Application Publication
(10) Pub. No.: US 2005/0256794 A1
(43) Pub. Date: Nov. 17, 2005

(54) Benefit financing arrangement

(76) Inventor: Ronald B. Colby, Minnetonka, MN (US)

Correspondence Address: FULBRIGHT & JAWORSKI L.L.P., 600 CONGRESS AVE., SUITE 2400, AUSTIN, TX, 78701, US

(21) Appl. No.: 11/096,203

(22) Filed: Mar. 31, 2005

Related U.S. Application Data
(60) Provisional application No. 60/558,859, filed on Apr. 2, 2004.

(51) Int. Cl. G06F 17/60

(52) U.S. Cl. 705/35; 705/4

(57) ABSTRACT

Methods and systems for funding a benefit and/or managing a benefit plan. A benefit account is established. The benefit account is funded. A line of credit is established. A benefit is paid from the benefit account, and, if the benefit account balance falls below a predetermined threshold, the benefit is paid from the line of credit.

This patent application claims priority to, and incorporates by reference in its entirety, U.S. provisional patent application Ser. No. 60/558,859 filed on Apr. 2, 2004, entitled, “A Benefit Financing Arrangement.”

### BACKGROUND OF THE INVENTION

1. Field of the Invention

The present invention relates generally to methods to fund benefits under a benefit plan. In some embodiments, the benefit plan is a health benefit plan sponsored by an employer for its employees.

2. Description of Related Art

In the past, health benefit plans have been offered through Administrative Services Only (ASO) plans. ASOs are sometimes referred to as an administrative service contract (ASC). Some ASOs involve a contract between an insurance company and a self-funded plan where the insurance company performs administrative services only and does not assume any risk. For example, if a company is under an ASO plan, it will make payments on its own to cover health care costs of its employees, and the insurance company will handle the administrative tasks.

In the past, ASOs were not readily accessible by some companies because of risk—e.g., if a large payment was required, the company might not be able to cover the costs. For this reason, some companies would employ an ASO coupled with stop loss insurance. Stop loss insurance would cover amounts over a certain amount, and the employer would of course have to pay premiums for this stop loss coverage. Still, even coupling the ASO with a stop loss insurance, there remain gaps for some companies between the amounts covered under the stop loss insurance and what the company can afford to self-fund.

These referenced shortcomings of conventional methodologies are not intended to be exhaustive, but rather are among others that tend to impair the effectiveness of previously known techniques for the tasks mentioned above. Other noteworthy problems may also exist; however, those mentioned here are sufficient to demonstrate that methodology appearing in the art have not been altogether satisfactory and that a significant need exists for the techniques described and claimed here.

### SUMMARY OF THE INVENTION

Shortcomings of the prior art are reduced or eliminated by the techniques disclosed here. These techniques include methods to provide payments for costs under a benefit plan from multiple sources (e.g., bank account, loan, insurance, and others).

These techniques are applicable to a vast number of situations, including situations that involve benefit plans for something other than health care benefits and include situations that involve benefit plans sponsored by an entity other than an employer sponsoring a plan for its employees.

A general embodiment involves automatically linking an ASO benefit plan (the “Plan”) to previously approved credit (e.g. line of credit from bank) and a stop loss insurance plan. As used here, “stop loss” and variants such as “stop loss insurance plan” should not be limited to traditional stop loss insurance currently known in the art but may also encompass a plan offered by a bank or other entity. More generally, the term may refer to a third tier of payment by a party who is not a customer. Under this embodiment, the Plan sponsor makes monthly payments into an account that is used to pay for the Plan benefit costs, administered by a separate entity (e.g. a third party administrator (a “TPA”)). “TPA” should not be limited to traditional TPAs currently known in the art and should be taken as encompassing the situation where, e.g., a broker, agent, or some other entity performs administration. If the account does not have enough funds available to cover a cost that the administrator has determined is covered under the Plan, a loan would automatically be extended to the Plan sponsor. The Plan sponsor would repay this loan through its continuing monthly payments into the account. If the limit of the previously approved credit is reached (preventing the extension of a loan to pay the cost), then the cost may be paid through stop loss insurance. If the administrator determined that the cost is not covered under the plan, the cost may be paid through funds in an account funded by a plan beneficiary.

Another embodiment involves a method of funding a benefit. A benefit account is established. The benefit account is funded. A line of credit is established. “Line of credit” should be interpreted according to its ordinary meaning and should not be taken as excluding lines of credits such as, e.g., credit cards, revolving lines of credit, or other types of credit financing known in the art. A benefit is paid from the benefit account, and, if the benefit account balance falls below a predetermined threshold, the benefit is paid from the line of credit.

This method may also include providing a stop-loss insurance policy and paying the benefit from stop-loss insurance policy proceeds if the line of credit reaches a credit limit or if a claim matches prespecified criteria. Funding the benefit may involve periodically funding a benefit account. The method may also include repaying the line of credit from the benefit account. The method may also include paying a premium for the stop-loss insurance policy from the benefit account. The method may also include establishing a benefit administration structure and paying fees for the administrative structure from the benefit account. The benefit may include a healthcare benefit. The benefit account may include an interest bearing account. The line of credit may include an interest bearing line of credit. The predetermined threshold triggering the line of credit payment may be $0.00. The benefit account may include an account maintained in a financial institution. The benefit account may include a trust account. The benefit plan may include a benefit plan sponsored by an employer to benefit employees of the employer. The benefit plan may include an ERISA plan. The method may also include offering an incentive if a balance of the benefit account is maintained in excess of a target value.

Another embodiment involves a system of managing a benefit plan, the system including a benefit account with an institution, a line of credit with an institution, and a benefit plan management data processor. The benefit plan management data processor is for servicing benefits payable from the benefit account and includes (a) means for paying benefits from the benefit account if an account balance of the benefit account is greater than a predetermined threshold and (b) means for paying benefits with funds from the line of credit if the balance of the benefit account is less than or equal to the predetermined threshold.

This system may also include means for periodically funding the benefit account. The system may also include a stop-loss insurance policy and means for paying benefits with proceeds from the stop-loss insurance policy if the line of credit reaches a predetermined credit limit or if a claim matches prespecified criteria.

Other features and associated advantages will become apparent with reference to the following detailed description of specific embodiments in connection with the accompanying drawings.

It will be understood by those having ordinary skill in the art that the techniques discussed here can be applied to different applications in different settings (e.g., settings that are not health care related and settings that do not involve employers or insurance companies). Along with this disclosure, the claims of this application take into account the breadth of the present invention.

### BRIEF DESCRIPTION OF THE DRAWINGS

The following drawings form part of the present specification and are included to further demonstrate certain non-limiting aspects of the present invention. The invention may be better understood by reference to one or more of these drawings in combination with the detailed description of specific embodiments presented herein.

FIG. 1 presents the relationship between a plan sponsor, the account, and possible other parties.

FIG. 2 presents steps entailed in creating an account under one embodiment of this invention.

FIG. 3 presents steps entailed in funding a benefit according to one embodiment of this invention.

FIG. 4 presents steps that may be required to maintain an account according to one embodiment of this invention.

FIG. 5 presents steps entailed in closing an account according to one embodiment of this invention.

FIG. 6 presents an example hardware implementation of the present invention, according to one embodiment utilizing the internet.

### DESCRIPTION OF ILLUSTRATIVE EMBODIMENTS

The terms “comprise” (and any form of comprise, such as “comprises” and “comprising”), “have” (and any form of have, such as “has” and “having”), and “include” (and any form of include, such as “includes” and “including”) are open-ended linking verbs. As a result, a method that “comprises,” “has,” or “includes” one or more steps possesses those one or more steps, but is not limited to possessing only those one or more steps.

The terms “a” and “an” are defined as one or more than one unless this disclosure or the claims explicitly require otherwise.

As may be appreciated from the claims, not all the steps or limitations displayed in the figures or listed in this detailed description of particular embodiments need to be present in all embodiments. Techniques of this disclosure can be accomplished using a subset of the steps and limitations described. In addition, neither the figures, the numbering in the figures, the arrows in the figure, the ordering in the figures, or this description are intended to suggest any ordering of the steps, unless the claimed embodiments explicitly indicate such an order. Furthermore, the illustrative embodiments described are not intended to be limiting as it is the claims that define the scope of the invention and it is the claims that define the limitations and steps required in each embodiment claimed.

For ease of description, the embodiments described in the detailed description are referred to as methods, and the parts of those methods as steps. However, embodiments may include computer readable medium comprising instructions for effecting particular methods, and steps within those methods, described herein. As is known in the art, the computer readable media may be associated with a computer, a software package, a hard drive, a floppy, a CD, a DVD, an instrument, an ASIC, firmware, a “plug-in” for other software, web-based applications, or the like. This list is not by way of limitation.

The use of the term “or” in the claims is used to mean “and/or” unless explicitly indicated to refer to alternatives only or the alternatives are mutually exclusive, although the disclosure supports a definition that refers to only alternatives and “and/or.”

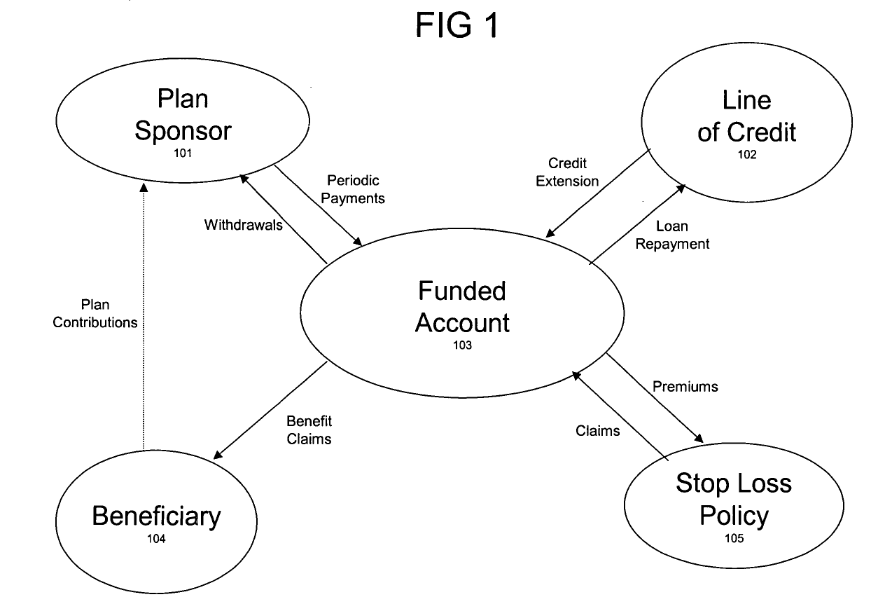

FIG. 1 represents a relationship between a fund sponsor 101, a funded account 103, a beneficiary 104 of the account, the entity that extends a line of credit 102, and a stop loss insurer 105. The fund sponsor 101 makes periodic payments to the account which may represent money withheld from the beneficiary 103. Additionally, money owned by the fund sponsor 101 can be withdrawn from the account. The line of credit 102 can be issued by any financial institution or other entity. This line of credit 102 may or may not be secured by other assets of the plan sponsor. The line of credit 102 will automatically transfer funds to the funded account 103 when a predetermined event occurs including but not limited to: inability to pay a given benefit, balance in account drops below a predetermined threshold, and/or periodically according to a predetermined schedule. The terms of the loan extended through the line of credit 102 can be any that are mutually agreeable to the fund sponsor and creditor. The payment for this loan may represent funds from subsequent periodic payments to the account 103, or may be made directly from the plan sponsor 101 to the line of credit lender (not shown). In the event that an insurable risk according to the stop loss insurance policy 105 arises, then payment will be made from the stop loss insurance 105 policy to the account 103. These events may include but are not limited to: exhaustion of preapproved credit according to the terms of the line of credit 102, a claim from a beneficiary 103 against the account 103 that matches prespecified criteria (e.g., a specific claim limit or a type of claim such as cancer), or a total amount of claims against account exceeding some prespecified threshold measured over some period. Premiums for this insurance protection may be paid directly out of the account 103 or may be paid directly from the fund sponsor 101 according to any schedule agreeable to the insurer and the fund sponsor. In addition, the amounts included in the periodic payments from the plan sponsor may partially represent money withheld from or on behalf of beneficiaries. It is shown as flowing from the beneficiary to the plan sponsor, but this may merely represent setoff, and in the case of a beneficiary not directly related to the plan sponsor, no money need be withheld or paid to the plan sponsor. This would occur in the case of the dependent of an employee of the plan sponsor, or in the case where the plan sponsor fully funds the benefits of the account without contribution from the employee. For these reasons it is indicated as a dashed line on FIG. 1.

The funded account 103 may earn interest and/or may comprise an account at any financial institution, although it is not so-limited. For example, funded account 103 may be, but is not limited to, a traditional deposit account. It may be any type of account suitable for the functions described here and may involve, e.g., pre-funded accounts, post-funded accounts, custodial accounts, an account at a non-bank, etc. In an account that earns interest, the interest earned may be paid in cash or credited to the account. The financial institution may, for example, comprise a bank, a financial holding company and/or a depository institution. The funded account 103 may also be insured up to the maximum insurance limit specified by the Federal Deposit Insurance Act and applicable regulations adopted by the FDIC. The funded account 103 may also comprise a trust account, an insurance company account, and/or a custodial account. The trust account may comprise a benefit trust account. The custodial account may be held at a bank, insurance company, investment company and/or financial holding company. The funded account 103 may also comprise an individual account or an omnibus account. As already explained, these illustrative embodiments are not intended to be limiting, as those of ordinary skill in the art will recognize that other variations, types, or entities are available.

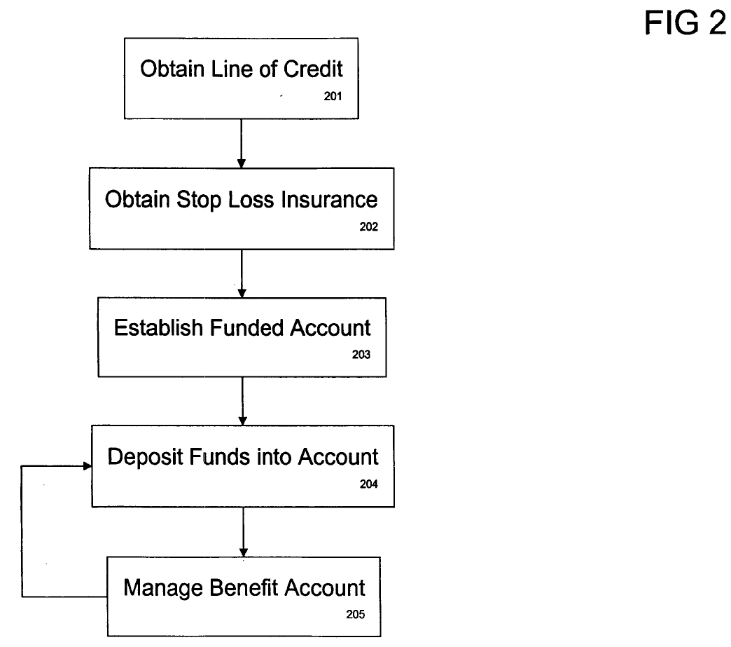

FIG. 2 represents the process flow involved in creating an account as illustrated in FIG. 1. The steps as shown are merely examples and do not necessarily have to occur in the order shown unless otherwise specified. In this embodiment, the process begins with contacting a bank or other financial institution to receive approval for a line of credit 102, shown as step 201. The terms of this line of credit 102 will vary depending on the relationship between the lender and the plan sponsor, and are well known to those of ordinary skill in the art.

Step 202 indicated on FIG. 2, comprises obtaining stop loss insurance 105 for protection against events including but not limited to: exceeding amount of credit obtained in step 201, certain classifications of claims against the account, or aggregate claims against account exceeding some threshold. The specific terms of this insurance may vary based on the relationship between the insurer and the plan sponsor, as well as the particular level of risk desired by the plan sponsor.

Step 203 indicated on FIG. 2, involves initial administrative steps involved in creating a funded account 103. These administrative steps may include: identifying account administrator, agreeing to terms, making an initial deposit of funds, notifying lender and insurer of account, setting up notifications of events affecting line of credit 102 or stop loss insurance 105, providing access for plan administrator, notifying beneficiaries as to how to file claims for benefits. The exhaustive list of steps necessary to establish a benefits account is well-known to those of ordinary skill in the art, and may vary based on the specific type of benefits provided for by the funded account 103. This invention is however, not limited to a specific type of benefit.

Step 204 indicated on FIG. 2, shows that a sequence of payments may be made to the account. The funds for these payments may comprise funds of any entity. As mentioned before, these payments may partially or fully represent funds withheld from employees of the plan sponsor or other related persons. This step 204 of periodically depositing funds into the account may contribute to repayment of a loan, whenever a loan is extended (see step 303, 403). These payments may be made on a regular and/or irregular basis including but not limited to: weekly, bi-weekly, semi-monthly, monthly, quarterly, semi-annually, or annually.

The funds deposited in step 204 may comprise an -amount for estimated benefits, for administrative fees, for stop loss insurance, for a fee for the previously approved credit, for a fee for a product or service ancillary to the benefit plan, and/or for a health network access fee. As a reminder, this list, as all other lists provided in this description are not intended to be limiting. For example, the funds may also comprise an amount for any other fee or cost. These amounts may comprise a fraction of a yearly amount for each respective fee (for example, 1/12, ½, 1/52, or any other fraction). These amounts may also comprise other fractions not necessarily tied to a yearly amount, or the full amount (that is, not a fraction) for a period (a week, month, day, year, etc.).

Periodically depositing funds into the account may comprise depositing funds into the account electronically, automatically, by personally going to a bank, by using cash, by using check, by using a money order, by using a wire transfer, and/or by any other recognized ways to deposit funds into an account.

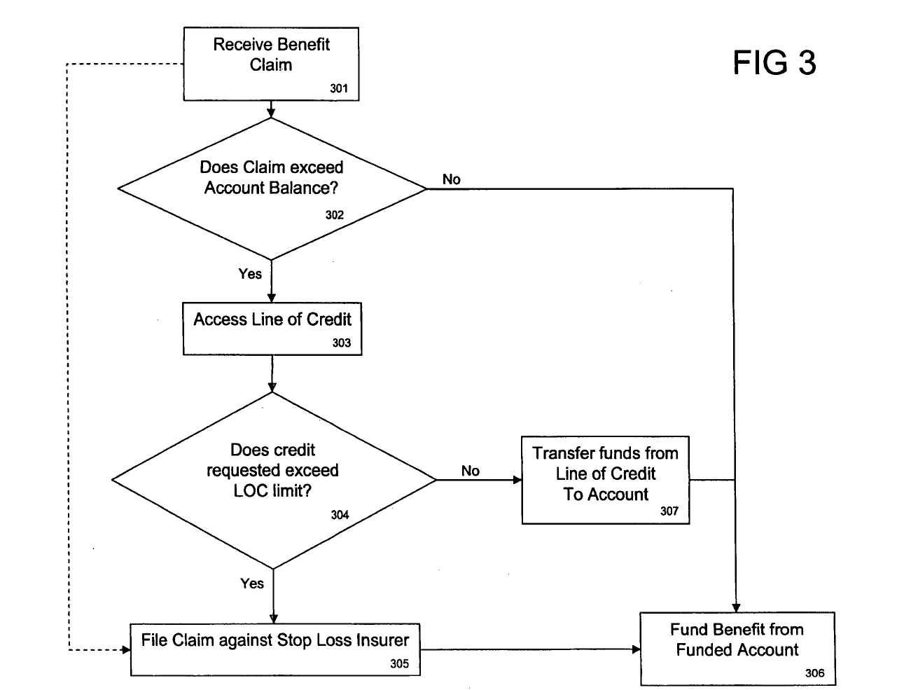

Step 205 indicated on FIG. 2, shows that this account may be managed for the purpose of at least but not limited to providing benefits. This step is followed by returning to step 204, but periodic deposits can be considered as part of maintaining the funded account 103, and the maintenance of the funded account 103 reflects funds available in the account, but need not otherwise be contingent on periodic payments. The maintenance of the account 103 is discussed in more detail in FIGS. 3 & 4. However, as indicated in FIG. 2, the initial steps of obtaining a line of credit 201, obtaining stop loss insurance 202, and establishing the benefit account 203 need not be repeated unless a change is desired.

FIG. 3 represents an example of steps that may be involved in funding a claim against the funded account 103. A simple example is a claim that does not exceed the funds available in the account. Funding a benefit claim 306 begins with the receipt of the claim represented by step 301. The benefit claim can be received either directly from the beneficiary or on behalf of the beneficiary through a service provider. The claim can be received in many forms including but not limited to: electronically, via telephone, via mail, or in person. Within step 301, it is assumed that the claim has already been approved as payable according to the terms of the benefit account.

Step 302 involves comparing the amount of the claim to the amount of funds available in the account. As illustrated, step 302 tests for whether or not the claim is greater than the available funds in the account. In other words, the test is whether or not the resulting balance in the account after funding the claim will be a number less than zero. The present invention is not limited to this type of test. Step 302 can easily be modified to reflect a resulting balance less than any threshold other than zero as desired by the plan sponsor. Based on this comparison, either the claim will be funded in step 306, or the method proceeds to step 303, which is accessing the line of credit 102.

Step 303 involves accessing the line of credit. Whether or not funds are transferred from the line of credit depends on the particular terms, but for illustrative purposes it is assumed that the line of credit 102 is based on a fixed amount of credit that can be extended, and is otherwise always available. The amount of credit requested may the full amount of the claim, the amount that the claim exceeds the value of the account, a predetermined amount, or a multiple of the above mentioned items.

Step 304 represents a decision made by either the administrator of the funded account 103 or the line of credit 102 lender regarding the amount of credit requested. This assumes that the amount of funds accessible through the line of credit does not vary based on requests made against the line of credit. Obviously, it can be renegotiated at any time in different embodiments, but it is assumed for purposes of this illustration that within the scope of funding an individual claim, the line of credit is fixed. If the amount of credit requested will not cause the loan issued under the line of credit to exceed the amount approved, then funds are transferred to the account 103 from the line of credit 102, and the benefit is funded 306. Otherwise, a claim is filed against the stop loss insurer as step 305. For this example it is assumed that exceeding available credit from line of credit is a covered event under the stop loss insurance policy.

Step 305 represents filing a claim against the stop loss insurer. As shown by the dotted line, this step may occur directly after receipt of a claim 301 assuming that the claim matches a predetermined criteria. Obviously, this involves a decision step which is not shown. Based on the claim, the stop loss insurer will transfer money to the account, which will proceed to funding at step 306.

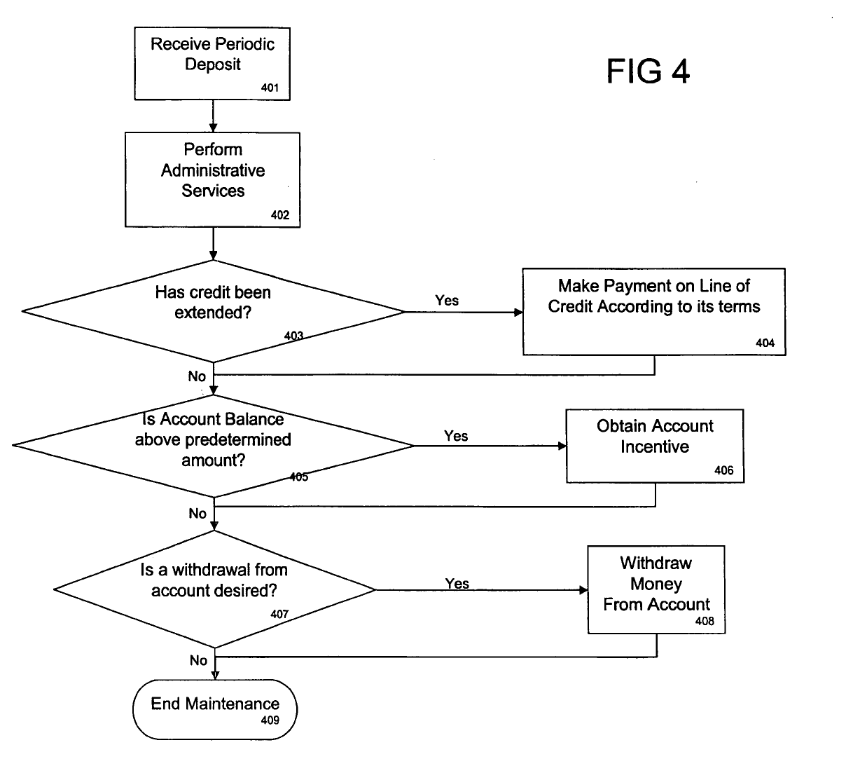

FIG. 4 illustrates example steps involved in maintaining the account previously indicated as step 205 of FIG. 2. As mentioned in the discussion of FIG. 1, payments into the account need not be periodic or regular, but for purposes of this illustration, it is assumed that the maintenance begins with receipt of a payment 401. It should be noted that the administrative steps shown need not be performed at the same frequency or even synchronized with the receipt of deposits or with other steps indicated.

Step 402 illustrates that the maintenance of the account may require general administration, which may include but is not limited to: the filing of documents, production of reports on a regular/irregular schedule, payment of stop loss insurance premiums, maintenance fees, regulatory filings, or benefit association membership fees. Assuming that administrative functions have been handled as appropriate to the specific function, the maintenance process continues to maintain funds in the account.

Step 403 illustrates dealing with the line of credit 102. If funds have been extended to the account from the line of credit, then payments 404 may need to made on the account. The account administrator may make the minimum payment 404 necessary according to the line of credit terms or may elect to pay all or a part of the principal balance on any loan balance associated with the line of credit 102. Assuming that there is no balance associated with the line of credit, then the method proceeds to step 405. It is possible that monthly maintenance payments are required for the line of credit, and these can either be addressed in step 402 (maintenance payment) or step 404 (line of credit payment) as appropriate depending on the status of the line of credit as determined in step 403.

Step 406 illustrates that there may be incentives attached to the account based on the available balance in the account. There can be a multitude of incentives attached to the account including but not limited to: a reduction in interest on the line of credit, the payment of interest on funds in the account and/or waiver of account fees. Step 406 illustrates an incentive based on account balance. If the account balance requirement is satisfied, the incentive will be realized at step 406. Conversely, steps 405 & 406 can relate to account penalties as well, which need not be based on the same or any account balance threshold nor mutually exclusive with account incentives. Examples of penalty events could include, but are not limited to: excess transactions, account balance below some threshold, breach of ancillary agreement.

Step 407 represents the fund sponsors elective ability to withdraw money from the account. This ability may be limited by factors such as legal restrictions or availability of funds. If a withdrawal is desired at step 407, then barring a restriction (not shown) the funds will be received at step 408. In the alternative, maintenance has been concluded and step 408 is still reached. The steps shown in FIG. 4 illustrate an example process flow relating to account maintenance, but the steps do not necessarily need to occur in the order shown and can be repeated as necessary.

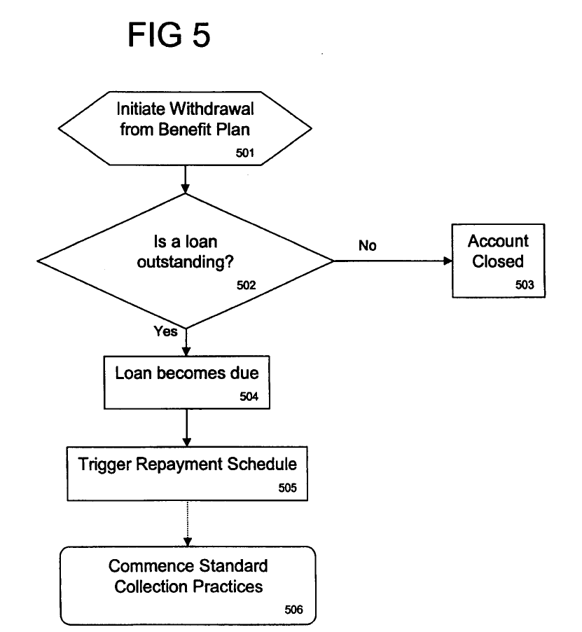

FIG. 5 represents example steps for withdrawing from a benefit financing arrangement. FIG. 5 may also reflect setting up a similar account under different terms or may be incident to dissolution of the plan sponsor's business or may simply reflect a desire to withdraw from a plan. Regardless of the reason, the process begins with step 501, which includes: forming the intent to withdraw from the plan, notifying interested parties, and other administrative tasks as needed. The specific steps depend on the reason for the withdrawal, and future plans, but are well known in the art. The steps also depend on whether the account is maintained by the plan sponsor or a third-party and any contractual relationship between them.

Step 502 evaluates whether the account has any outstanding loan extended from the line of credit 102. If not, then the account can immediately be closed as step 503, notwithstanding any agreement to the contrary. Otherwise, the process proceeds to step 504 where the loan becomes due. Once the loan becomes due in step 504, payment can be remitted immediately from the plan sponsor, the remaining account balance, or any other entity Otherwise, the process proceeds to step 505, where any previously agreed upon repayment schedule is triggered or alternatively a default repayment schedule is activated as determined by applicable law. Step 505 may be maintained unless and until the account enters default at which point standard collection practices commence as step 506. The process for withdrawal from the account may be limited by applicable laws and agreements.

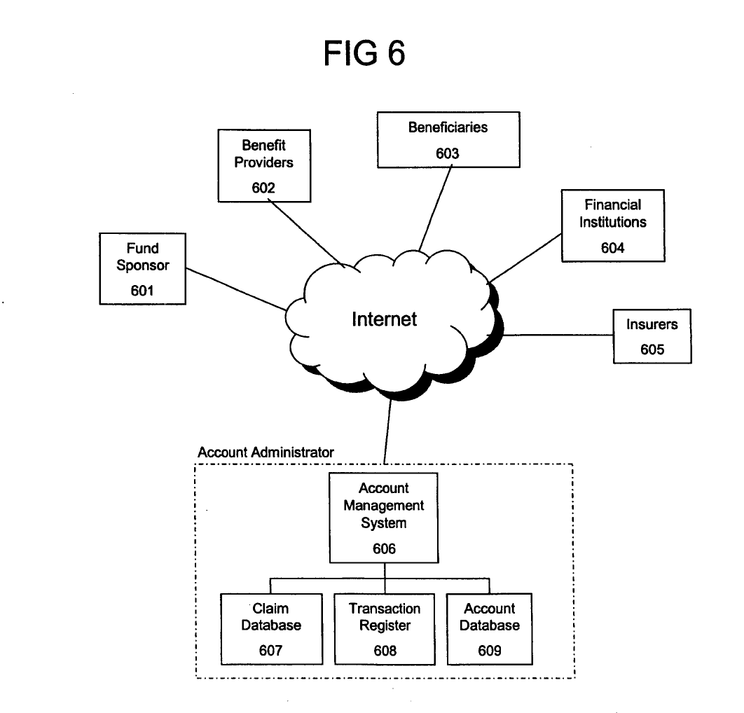

FIG. 6 represents an example hardware implementation of embodiments of the present invention utilizing the internet to effect communication between different entities. The fund sponsor 601, benefit provider 602, beneficiaries 603, financial institutions 604, and insurers 605 can contact and be contacted by the Account Management System 606. The Account Management System 606 effects some or all of the maintenance functions utilized by this invention. For example, a claim may be initiated by a benefit provider 602, which is connected to the Account Management System 606 via internet. The Account Management System may update the Claims Database 607 with the claim information and status. The status of the account may be evaluated by utilizing either the Account Database 609 or contacting Financial Institutions 604 via the internet or a combination of the two. From this evaluation a decision as to how to fund the claim can be made as taught by the present invention. Furthermore, the funding of the claim can be performed through the internet by initiating the transfer of funds directly to the account of the benefit provider 602 at a financial institution 604 or the issuance of a check or other payment tangible to the benefit provider 602. This can be performed directly between financial institutions, between financial institutions and beneficiaries, between financial institutions and benefit providers, either directly or on behalf of an entity. Any transactions made including the funding of the account may be recorded in the Transaction Register 608. The same steps can be carried out by using communication methods other than the internet.

The steps illustrated above are only examples and may vary depending on the particular function being carried out, including but not limited to: receipt of deposited funds, claims against stop loss insurer, accessing line of credit, paying premium for insurance, or sending notification or reports to a party. Furthermore, the entities reflected on FIG. 6 need not be separate or plural. It is possible to have an account managed by an insurer or a financial institution, which may be the same entity.

The administrative services disclosed here may be part of an Administrative Services Only (ASO) benefit plan. The administrative services may comprise the entity using funds from the funded account to pay for a benefit (see step 306), an administrative fee, a stop loss premium, a fee for the previously approved credit, a fee for a product or service ancillary to the benefit plan and/or a health network access fee, among other things. Using funds from the funded account to pay for a benefit may be done at the occurrence of a claim, daily, weekly, monthly, and/or at any other period or time. The administrative services may also comprise determining whether costs are covered under the benefit plan. When costs are not covered, a separate account established by or on behalf of an individual beneficiary of the benefit plan may be used to fund costs not covered by the benefit plan. This account may comprise a Health Savings Account, a Health Reimbursement Account, a Flexible Spending Account, etc (an “Individual Account”). In some embodiments this may result in a seamless transaction from a benefit provider's point of view, as the benefit provider may simply submit a claim to get paid, instead of being told that such claim is not covered under the plan and being referred back to the plan beneficiary to collect the cost for the services provided (as it is usually done in traditional insurance plans).

The entity performing the administrative services may comprise a third party administrator (TPA), a financial institution, an insurance company, an administrator, a financial holding company, an investment company and/or any other entity able to perform administrative services. The financial institution may comprise, for example, a bank.

It should be understood that the present methods are not intended to be limited to the particular forms disclosed. Rather, they are to cover all modifications, equivalents, and alternatives falling within the scope of the claims. Furthermore, the claims are not to be interpreted as including means-plus- or step-plus-function limitations, unless such a limitation is explicitly recited in a given claim using the phrases(s) “means for” or “step for,” respectively.

Moreover, the preceding examples are included to demonstrate specific embodiments of this disclosure. It should be appreciated by those of ordinary skill in the art that the techniques disclosed in these examples represent techniques discovered by the inventors to function well in the practice of the invention, and thus can be considered to constitute specific modes for its practice. However, those of ordinary skill in the art should, in light of the present disclosure, appreciate that many changes can be made in the specific embodiments which are disclosed and still obtain a like or similar results without departing from the spirit and scope of the invention. With the benefit of the present disclosure, those having skill in the art will comprehend that techniques claimed here may be modified and applied to a number of additional, different applications, achieving the same or a similar result. The claims cover all such modifications that fall within the scope and spirit of this disclosure.

1. A method of funding a benefit, comprising:
establishing a benefit account;
funding the benefit account;
establishing a line of credit; and
paying a benefit from the benefit account, and, if the benefit account balance falls below a predetermined threshold, paying the benefit from the line of credit.

2. The method of claim 1, further comprising:
providing a stop-loss insurance policy; and
paying the benefit from stop-loss insurance policy proceeds if the line of credit reaches a credit limit or if a claim matches prespecified criteria.

3. The method of claim 1, the funding step comprising, periodically funding the benefit account.

4. The method of claims 1, further comprising, repaying the line of credit from the benefit account.

5. The method of claim 2, further comprising, paying a premium for the stop-loss insurance policy from the benefit account.

6. The method of claim 1, further comprising:
establishing a benefit administration structure; and
paying fees for the administrative structure from the benefit account.

7. The method of claim 1, the benefit comprising a healthcare benefit.

8. The method of claim 1, the benefit account comprising an interest bearing account.

9. The method of claim 1, the line of credit comprising an interest bearing line of credit.

10. The method of claim 1, the predetermined threshold being $0.00.

11. The method of claim 1, the benefit account comprising an account maintained in a financial institution.

12. The method of claim 1, the benefit account comprising a trust account.

13. The method of claim 1, the benefit plan comprising a benefit plan sponsored by an employer to benefit employees of the employer.

14. The method of claim 1, the benefit plan comprising an ERISA plan.

15. The method of claim 1, further comprising, offering an incentive if a balance of the benefit account is maintained in excess of a target value.

16. A system of managing a benefit plan, comprising:
a benefit account with an institution;
a line of credit with an institution;
a benefit plan management data processor for servicing benefits payable from the benefit account, including:
means for paying benefits from the benefit account if an account balance of the benefit account is greater than a predetermined threshold; and
means for paying benefits with funds from the line of credit if the balance of the benefit account is less than or equal to the predetermined threshold.

17. The system of claim 16, further comprising, means for periodically funding the benefit account.

18. The system of claim 16, further comprising:
a stop-loss insurance policy; and
means for paying benefits with proceeds from the stop-loss insurance policy if the line of credit reaches a predetermined credit limit or if a claim matches prespecified criteria.
